(19) United States
(12) Patent Application Publication
(10) Pub. No.: US 2023/0082643 A1
(43) Pub. Date: Mar. 16, 2023

(54) SURFACE TREATMENT FOR COLLOIDAL STABILITY OF IN-SOLUTION LIGAND EXCHANGED QUANTUM DOTS

(71) Applicant: Lawrence Livermore National Security, LLC, Livermore, CA (US)

(72) Inventors: Tom Nakotte, Dublin, CA (US); Jinkyu Han, San Ramon, CA (US); Anna Hiszpanski, Pleasanton, CA (US)

(21) Appl. No.: 17/473,712

(22) Filed: Sep. 13, 2021

(51) Int. Cl. C09C 3/08; C01B 19/00; C09C 1/00

(52) U.S. Cl. CPC C09C 3/08; C01B 19/007; C09C 1/00; B82Y 40/00

(57) ABSTRACT

A product includes a solution comprising Ag₂Se quantum dots in a solvent. The solution is colloidally stable for at least one week. A product includes a solid layer formed of Ag₂Se quantum dots. The layer is at least 100 nm thick. The layer is physically characterized by a substantial absence of defects therein. A process includes forming a solution of Ag₂Se quantum dots and adding at least acetonitrile to the solution. The process further includes separating the Ag₂Se quantum dots from the solution and washing the Ag₂Se quantum dots at least two times in a solution comprising at least acetonitrile. The process further includes redispersing the washed Ag₂Se quantum dots in a nonpolar solvent to create a colloidal suspension.

This invention was made with Government support under Contract No. DE-AC52-07NA27344 awarded by the United States Department of Energy. The Government has certain rights in the invention.

### FIELD OF THE INVENTION

The present invention relates to quantum dots, and more particularly, this invention relates to surface treatment methods to improve colloidal stability of in-solution ligand exchanged Ag₂Se quantum dots.

### BACKGROUND

Quantum dots may be used as sensing and active materials for a variety of optoelectronic devices, most recently including infrared (IR) photodetectors, cameras, etc. Quantum dot-based IR photodetectors have the potential to achieve high detection sensitivity at high operation temperatures compared with conventional commercial IR cameras, thereby significantly reducing the cost of IR cameras, as well as their size, weight, power, etc., requirements.

### SUMMARY

A product, according to one general aspect, includes a solution comprising Ag₂Se quantum dots in a solvent. The solution is colloidally stable for at least one week.

A product, according to one general aspect, includes a solid layer formed of Ag₂Se quantum dots. The layer is at least 100 nm thick. The layer is physically characterized by a substantial absence of defects therein.

A process, according to one general aspect, includes forming a solution of Ag₂Se quantum dots and adding at least acetonitrile to the solution. The process further includes separating the Ag₂Se quantum dots from the solution and washing the Ag₂Se quantum dots at least two times in a solution comprising at least acetonitrile. The process further includes redispersing the washed Ag₂Se quantum dots in a nonpolar solvent to create a colloidal suspension.

Other aspects and advantages of the present invention will become apparent from the following detailed description, which, when taken in conjunction with the drawings, illustrate by way of example the principles of the invention.

### BRIEF DESCRIPTION OF THE DRAWINGS

FIG. 1 is a flowchart of a process, according to an aspect of the present invention.

FIG. 2 is a plot of Fourier-transform infrared spectroscopy (FTIR) data after ligand exchange, according to an aspect of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

The following description discloses several preferred aspects of surface treatment methods to improve colloidal stability of in-solution ligand exchanged Ag₂Se quantum dots and/or related systems and methods.

In one general aspect, a product includes a solution comprising Ag₂Se quantum dots in a solvent. The solution is colloidally stable for at least one week.

In another general aspect, a product includes a solid layer formed of Ag₂Se quantum dots. The layer is at least 100 nm thick. The layer is physically characterized by a substantial absence of defects therein.

In yet another general aspect, a process includes forming a solution of Ag₂Se quantum dots and adding at least acetonitrile to the solution. The process further includes separating the Ag₂Se quantum dots from the solution and washing the Ag₂Se quantum dots at least two times in a solution comprising at least acetonitrile. The process further includes redispersing the washed Ag₂Se quantum dots in a nonpolar solvent to create a colloidal suspension.

Quantum dots may be used as sensing and active materials for a variety of optoelectronic devices, most recently including infrared (IR) photodetectors, cameras, etc. Colloidal quantum dots solutions are of interest for a number of optoelectronic device applications where colloidal quantum dots are chemistry-tunable solutions of semiconductors, thereby enabling less costly device fabrication on a greater variety of substrates. Quantum dots are typically cleaned following colloidal quantum dot synthesis and prior to use in optoelectronic devices. Conventional cleaning methods include removing electrically insulating ligands that are necessary during the synthesis process in order to keep the quantum dots well dispersed and in solution. Cleaning the synthesized quantum dots can be challenging to do without causing the quantum dots to aggregate and crash out of the solution.

Ag₂Se quantum dots with an excess of Ag have an intraband transition corresponding with mid-IR light absorption (e.g., about 3 to 5 microns). Therefore, Ag₂Se quantum dots are specifically of high interest as a potentially low-toxicity material for quantum dot-based mid-IR detectors.

Ag₂Se quantum dots formed by known methods may be characterized as having weakly binding surface ligands (e.g., post synthesis) which can be easily stripped during purification with common polar solvents (e.g., ethanol and methanol) causing colloidal instability. Relatively longer surface ligands have detrimental effects on the performance of devices constructed using quantum dot films. Ag₂Se quantum dots formed by known methods are not redispersable after multiple purification steps. However, quantum dots made with other semiconductors (e.g., such as PbSe or CdSe) may be able to sustain multiple purification steps.

Previous attempts at fabricating Ag₂Se quantum dot films for optoelectronic devices have been performed using solid state ligand exchange. Specifically, conventional Ag₂Se quantum dot films are produced using solid state layer-by-layer ligand exchange. Solid state ligand exchange conventionally comprises a process in which relatively longer ligands attached to the quantum dot surface are replaced with relatively shorter ligands after deposition of a quantum dot film. Solid state ligand exchange may lead to discontinuities as films become thicker, as the space taken up by the longer ligands is no longer filled when they are replaced with shorter ligands. Additionally, exposure of the quantum dots films to various solvents used in solid state ligand exchange can negatively impact the film quality.

In stark contrast, according to various aspects of the present disclosure, an in-solution method for ligand exchange mitigates the foregoing challenges by enabling the creation of thicker films and removing the need for post-deposition film treatments aimed at decreasing interdot distance within the films. The colloidal stability is a prerequisite for successfully performing in-solution ligand exchange. At least some aspects of the present disclosure include purifying the Ag₂Se quantum dots, thereby enabling fabrication of homogeneous and thick Ag₂Se quantum dot films substantially without film discontinuities. In various aspects, in-solution ligand exchange as described herein may be used with film deposition methods including, spray-coating, ink-jet printing, etc.

In at least some aspects, Ag₂Se quantum dots may be purified in a solution characterized by colloidal stability after multiple cleaning procedures (e.g., cycles), thereby improving optoelectronic device film quality and performance. Furthermore, at least some approaches as described herein use purified Ag₂Se quantum dots in an in-solution ligand exchange approach. At least some aspects of the in-solution ligand exchange process described herein use a phase transfer reaction to change the surface ligands of the Ag₂Se quantum dots to desired ligands. The in-solution ligand exchange process described herein maintains colloidal stability of Ag₂Se quantum dots even after replacement of longer ligands with shorter ligands. Relatively longer ligands are useful for maintaining colloidal stability in-solution. Relatively shorter ligands improve carrier transport within a quantum dot film by decreasing interdot distance. In one exemplary aspect, dispersed Ag₂Se quantum dots in 2,6-diflouropyridine (DFP) maintain their colloidal stability over the course of several days, and in many cases, several weeks.

In various aspects, a product comprises a solution comprising Ag₂Se quantum dots in a solvent where the solution is colloidally stable for at least one week. Colloidally stable as referred to throughout the present disclosure may refer to a solution comprising Ag₂Se quantum dots where no more than 5 wt % of the Ag₂Se quantum dots relative to the total weight of the Ag₂Se quantum dots settle out in one week. The inventors were surprised that the Ag₂Se quantum dots did not settle out after extended lengths of time including a few days, a few weeks, etc., as one skilled in the art would have expected based on the characteristics of existing quantum dot solutions. In at least some aspects, the solvent of the product comprising the Ag₂Se quantum dots is non-polar. In one approach, the Ag₂Se quantum dots have an average diameter in at least one direction in a range between about 3 nm and about 10 nm.

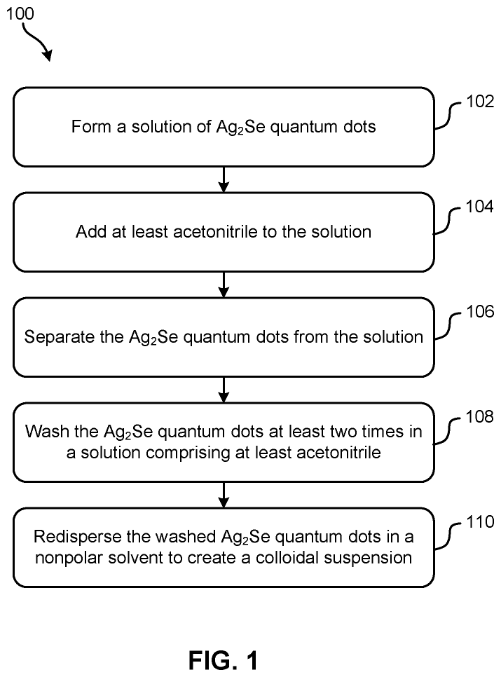

In various aspects, the product comprising the Ag₂Se quantum dots in the solution are physically characterized as having ligands that were attached thereto in a solution-based ligand exchange as described in detail below with reference to FIG. 1. Specifically, the solution-based ligand exchange according to at least some aspects described herein imparts a new physical characteristic on the Ag₂Se quantum dots, namely relatively shorter ligands than ligands which were coupled to the Ag₂Se quantum dots after fabrication and washing thereof.

In at least some aspects, the Ag₂Se quantum dots include an excess of silver present in the Ag₂Se quantum dots. An excess of silver as referred to herein refers to a total amount of silver on average in the Ag₂Se quantum dots that is above the stoichiometric ratio of 2:1 of Ag:Se in Ag₂Se. Accordingly, as described herein, Ag₂Se quantum dots may include an excess of silver in any of the disclosed aspects.

In one approach, the solution comprising Ag₂Se quantum dots in the solvent is used to form a product comprising a solid layer formed of the Ag₂Se quantum dots. In preferred aspects the layer is at least 100 nm thick, and ideally, formed in a single deposition to its final thickness or at least to 100 nm thick or greater per sub-layer. The layer is physically characterized by a substantial absence of defects therein. Defects as referred to throughout the present disclosure may refer to, and/or be used interchangeably with, discontinuities, cracking, gaps, etc. In stark contrast, films of quantum dots formed using solid state ligand exchange are expected to have various defects throughout said film. Furthermore, films of quantum dots formed using solid state ligand exchange are relatively thin (e.g., less than 100 nm) and multiple layers would be needed to achieve a thickness of 100 nm. The interfaces between the laminated layers provide more likelihood of formation of defects.

Referring again to the inventive layer, in at least one approach, the layer is in a focal plane array with numerous pixels present over area of at least a few square millimeters. In another approach, the layer is in a single pixel which is typically on the micron length scale. In various approaches, a product comprising the layer is an infrared light detector.

FIG. 1 is a flowchart of a process 100, in accordance with one aspect. As an option, the present process 100 may be implemented for purifying and forming colloidally stable solutions of Ag₂Se quantum dots such as those shown in the other FIGS. described herein. Of course, however, this process 100 and others presented herein may be used to form films comprising Ag₂Se quantum dots which may or may not be related to the illustrative aspects listed herein. Further, the processes presented herein may be carried out in any desired environment. Moreover, more or less operations than those shown in FIG. 1 may be included in process 100, according to various aspects. It should also be noted that any of the aforementioned features may be used in any of the aspects described in accordance with the various processes.

Process 100 includes step 102. Step 102 includes forming a solution of Ag₂Se quantum dots. Forming the Ag₂Se quantum dots and/or forming the solution of Ag₂Se quantum dots may be performed using a reaction known in the art. In a preferred aspect, an excess of silver is provided to conventional synthesis processes, in a manner which would become apparent to one having ordinary skill in the art upon reading the present disclosure.

In at least some aspects, the formed Ag₂Se quantum dots have an average diameter in at least one direction in a range between about 3 nm and about 10 nm. In various approaches, the Ag₂Se quantum dots are formed via hot injection, etc. In at least one approach, injected Ag₂Se quantum dots are left to grow in solution for about 0 to about 6 minutes and the solution is quenched with an H₂O bath and/or with a solvent injection comprising butanol, ethanol, etc.

In at least some aspects, forming the solution of Ag₂Se quantum dots includes quenching a Ag₂Se quantum dots synthesis reaction with butanol. Exemplary Ag₂Se quantum dots synthesis reactions comprise Ag₂Se quantum dots, oleylamine, AgNO₃, TOPSe, etc. An exemplary reaction may include 10 mL of oleylamine+0.5 mmol AgNO₃+0.24 mL 1M TOPSe with the Ag₂Se quantum dots.

Step 104 includes adding at least acetonitrile to the solution. In at least some approaches, chloroform may be added to the solution. In one exemplary reaction, about 10 mL of acetonitrile and/or about 10 mL of chloroform (CHCl₃) are added to the solution.

Step 106 includes separating the Ag₂Se quantum dots from the solution. In some approaches, the Ag₂Se quantum dots may be separated from the solution via centrifuge, filtering, distilling, extraction, etc. In a preferred approach, the Ag₂Se quantum dots are centrifuged and crashed out of the solution in a manner which would become apparent to one having ordinary skill in the art upon reading the present disclosure. For example, in one exemplary approach, the Ag₂Se quantum dots are centrifuged at 8000 rpm for 5 minutes. The parameters for centrifugation may vary and be determinable by one having ordinary skill in the art. The Ag₂Se quantum dots may be separated from the solution in any manner known in the art.

Step 108 includes washing the Ag₂Se quantum dots at least two more times in a solution comprising at least acetonitrile and chloroform. In various approaches, the Ag₂Se quantum dots are washed a total of two or more times, such as 2 times, 3 times, 4 times, 5 times, etc. Washing the Ag₂Se quantum dots according to at least some of the aspects described herein removes organic material from the formed Ag₂Se quantum dots (e.g., including unwanted ligands other than “surface” ligands, etc.). In one exemplary aspect, after a first wash, 2 mL of oleylamine may be added to the Ag₂Se quantum dots in the solution.

In at least some aspects, cleaning with acetonitrile, rather than conventional ethanol, allows surface ligands to remain attached after multiple cleanings. The inventors were surprised that the Ag₂Se quantum dots were able to withstand multiple cleanings. It was unexpected that multiple cleanings would result in maintained colloidal stability and prevent the Ag₂Se quantum dots from precipitating out of solution. One having ordinary skill in the art would expect the surface ligands of quantum dots to denature after two or more cleanings.

In various aspects, the washed Ag₂Se quantum dots may be redispersed in chloroform with acetonotrile acting as an antisolvent. The solution comprising the redispersed Ag₂Se quantum dots, acetonitrile, and chloroform may be centrifuged such that the Ag₂Se quantum dots crash out of the solution.

In one exemplary aspect, the Ag₂Se quantum dots may be redispersed in 10 mL of chloroform adding about 5 mL to about 10 mL of acetonitrile until the solution becomes slurried, as would be understood by one having ordinary skill in the art, before the solution is centrifuged and the Ag₂Se quantum dots crashed out of the solution.

Step 110 includes redispersing the washed Ag₂Se quantum dots in a nonpolar solvent to create a colloidal suspension with a concentration between about 5 mg/mL and about 20 mg/mL. In preferred aspects, the nonpolar solvent includes chloroform, hexane, etc.

The quantum dots with ligands produced by process 100 may be subjected to a solution-based ligand exchange. The Ag₂Se quantum dots may have relatively longer ligands prior to the solution-based ligand exchange. For example, the Ag₂Se quantum dots may comprise alkyl chain ligands following the formation and washing steps described above. These organic chains are beneficial for solubility but are detrimental to charge and/or electricity transfer capabilities of the Ag₂Se quantum dots (e.g., for use in optoelectronic devices, etc.). The solution-based ligand exchange, according to various aspects described herein, improves upon conventional solid state ligand exchange which occurs once a film has been deposited on a detector device and/or substrate. Conventional solid state ligand exchange requires many layers to develop a thick film (e.g., greater than 100 nm). Solid state ligand exchange is also susceptible to cracking, especially as the number of layers and/or thickness of the film increases. In stark contrast, a relatively thick, single layer film may be deposited following the solution-based ligand exchange processes described herein. In one aspect, a thick film may be considered a film having a deposition thickness of between about 100 nm and 1 μm. As would become apparent to one having ordinary skill in the art, thicker films are preferred and have better performance for various of the intended applications described herein.

In at least one aspect, the solution-based ligand exchange is performed by a phase transfer process. The phase transfer process includes contacting the colloidal suspension (e.g., in hexane) with a second solution having a ligand in a second solvent that is immiscible with the nonpolar solvent. The second solvent may comprise N-dimethylformamide, methanol, dimethyl sulfoxide, etc. The phase transfer process includes agitating the colloidal suspension with the second solution to intermix the Ag₂Se quantum dots in the colloidal suspension with the second solution whereby the ligand exchange occurs, in a manner which would be understood by one having ordinary skill in the art upon reading the present disclosure. The Ag₂Se quantum dots (e.g., now comprising the different ligands from the second solution) may be separated from the agitated mixture, using a technique known in the art, and the Ag₂Se quantum dots having the different ligands may be dispersed in a solvent to create a second colloidal suspension. An exemplary solvent for creating the second colloidal suspension may include 2,6-diflouropyridine.

In various approaches, the ligand(s) in the second solution may be x-type ligands including halides (e.g., halide-based ligands, ZnI₂, KI, NH₄I, etc.), CN, NO (bent), etc. In other approaches, the ligand(s) in the second solution are thiol-based ligands, iodide-based ligands, etc. In preferred aspects, the ligand(s) in the second solution are ZnI₂, tetrabutylammonium iodide, 1,2-ethanedithiol, etc. The ligand(s) in the second solution which are exchanged with the ligands on the Ag₂Se quantum dots (e.g., following formation and washing) are preferably relatively shorter than the ligands that are being exchanged. For example, relatively shorter ligands tend to increase conductivity of a layer formed of the Ag₂Se quantum dots.

In an exemplary aspect, the phase transfer process includes dispersing the Ag₂Se quantum dots from the colloidal solution comprising the Ag₂Se quantum dots (e.g., step 110) in hexane. An iodide-based ligand including ZnI₂ or tetrabutylammonium iodide are dissolved in N-dimethylformamide (DMF) to about 100 mg/mL. The Ag₂Se quantum dots in hexane are added to the ligand-DMF solution and agitated until the Ag₂Se quantum dots transfer into the DMF phase. The mixture is centrifuged to crash out the Ag₂Se quantum dots. If needed, as would be determinable by one having ordinary skill in the art, a relatively small amount of ethanol (e.g., between about 1 mL per 5 mL of DMF) may be added to allow for easier precipitation. The Ag₂Se quantum dots are redispersed in 2,6-diflouropyridine (DFP) to a desired concentration which would be determinable by one having ordinary skill in the art in view of the intended application. For example, relatively higher concentrations may be desirable for relatively thicker films, as would become apparent to one having ordinary skill in the art upon reading the present disclosure.

In an alternative aspect, the solution-based ligand exchange is performed by a non-phase transfer process. The non-phase transfer process includes contacting the colloidal suspension in chloroform with a second solution having a ligand in a second solvent that is miscible with the nonpolar solvent. An exemplary solution may include N-dimethylformamide. The non-phase transfer process includes agitating the colloidal suspension with the second solution to intermix the Ag₂Se quantum dots in the colloidal suspension with the second solution whereby the ligand exchange occurs, in a manner which would be understood by one having ordinary skill in the art upon reading the present disclosure. The Ag₂Se quantum dots (e.g., now comprising the different ligands from the second solution) may be separated from the agitated mixture, in a manner known in the art, and the Ag₂Se quantum dots having the different ligands may be dispersed in a solvent to create a second colloidal suspension. An exemplary solvent may include 2,6-diflouropyridine. The ligand(s) in the second solution may include any of the ligand(s) in the second solution described with respect to the phase transfer process.

In an exemplary aspect, the non-phase transfer includes dispersing the Ag₂Se quantum dots from the colloidal solution comprising the Ag₂Se quantum dots (e.g., step 110) in chloroform. An iodide-based ligand, such as those described above, is dissolved in DMF to about 100 mg/mL. The Ag₂Se quantum dots in chloroform are added to the ligand-DMF solution and agitated for a few seconds. The agitation is performed for an amount of time which would be determinable by one having ordinary skill in the art. For example, the solution including the Ag₂Se quantum dots in chloroform and the ligand-DMF solution may be agitated until the solution appears cloudy and/or slurried, as would become apparent to one having ordinary skill in the art upon reading the present disclosure. The mixture is centrifuged to crash out the Ag₂Se quantum dots. A relatively small amount of ethanol (e.g., between about 1 mL per 5 mL of DMF) may be added to aid precipitation. The Ag₂Se quantum dots are redispersed in 2,6-diflouropyridine (DFP) to a desired concentration which would be determinable by one having ordinary skill in the art in view of the intended application.

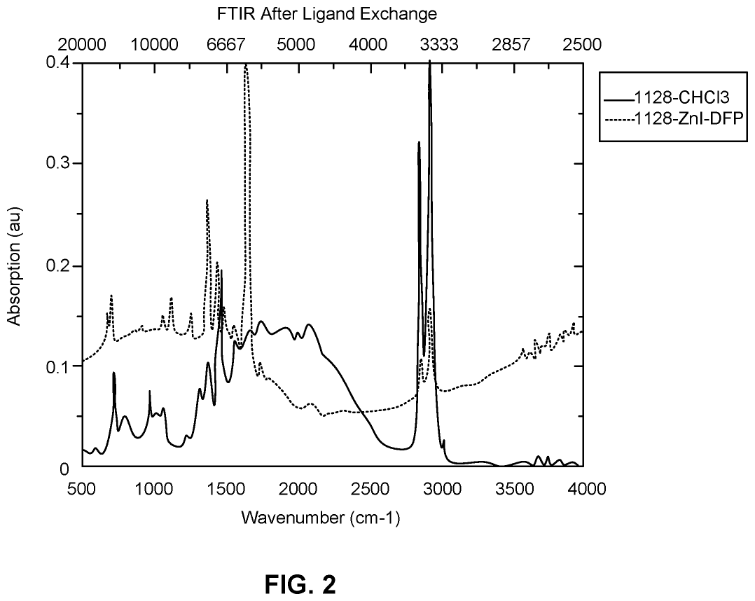

FIG. 2 depicts a plot of Fourier-transform infrared spectroscopy (FTIR) data after ligand exchange, in accordance with one aspect. The significant decrease in peaks located near 2900 cm⁻¹ indicate a reduction of the presence of C—H bonds associated with alkyl chains.

In Use

In one approach, the colloidal solution comprising Ag₂Se quantum dots formed according to at least some of the aspects herein may be used to form a product having a solid layer formed of the Ag₂Se quantum dots. In at least one approach, the layer is in a focal plane array. In another approach, the layer is in a single pixel. In various approaches, the product comprising the layer is an infrared light detector. The colloidal stability of the solution comprising Ag₂Se quantum dots enables deposition of films via spray coating, ink jet printing, etc. The Ag₂Se quantum dots are substantially ordered when deposited due to the colloidal stability of the solution prior to and after the solution-based ligand exchange. Such ordering contributes to the substantial lack of defects in the single, relatively thick layer as described herein.

The colloidal solution comprising Ag₂Se quantum dots and/or the product having a layer formed of the Ag₂Se quantum dots may be used in sensing and active materials for a variety of optoelectronic devices including infrared (IR) photodetectors, cameras, quantum dots-based IR photodetectors, etc.

The inventive concepts disclosed herein have been presented by way of example to illustrate the myriad features thereof in a plurality of illustrative scenarios, embodiments, and/or implementations. It should be appreciated that the concepts generally disclosed are to be considered as modular, and may be implemented in any combination, permutation, or synthesis thereof. In addition, any modification, alteration, or equivalent of the presently disclosed features, functions, and concepts that would be appreciated by a person having ordinary skill in the art upon reading the instant descriptions should also be considered within the scope of this disclosure.

While various embodiments have been described above, it should be understood that they have been presented by way of example only, and not limitation. Thus, the breadth and scope of an embodiment of the present invention should not be limited by any of the above-described exemplary embodiments, but should be defined only in accordance with the following claims and their equivalents.

What is claimed is:

1. A product, comprising:
a solution comprising Ag₂Se quantum dots in a solvent,
wherein the solution is colloidally stable for at least one week.

2. The product as recited in claim 1, wherein the solvent is non-polar.

3. The product as recited in claim 1, wherein the Ag₂Se quantum dots in the solution are physically characterized as having ligands that were attached thereto in a solution-based ligand exchange process.

4. The product as recited in claim 1, wherein an excess of silver is present in the quantum dots.

5. The product as recited in claim 1, wherein an average diameter of the Ag₂Se quantum dots is in a range of about 3 nm to about 10 nm.

6. A product, comprising:
a solid layer formed of Ag₂Se quantum dots,
the layer being at least 100 nm thick,
the layer being physically characterized by a substantial absence of defects therein.

7. The product as recited in claim 6, wherein the layer is in a focal plane.

8. The product as recited in claim 6, wherein the layer is in a single pixel.

9. The product as recited in claim 6, wherein the product is an infrared light detector.

10. A process, comprising:
forming a solution of Ag₂Se quantum dots,
adding at least acetonitrile to the solution;
separating the Ag₂Se quantum dots from the solution;
washing the Ag₂Se quantum dots at least two times in a solution comprising at least acetonitrile; and
redispersing the washed Ag₂Se quantum dots in a nonpolar solvent to create a colloidal suspension.

11. The process as recited in claim 10, comprising performing a solution-based ligand exchange.

12. The process as recited in claim 11, wherein the solution-based ligand exchange is performed by a phase transfer process.

13. The process as recited in claim 12, wherein the phase transfer process includes contacting the colloidal suspension with a second solution having a ligand in a second solvent that is immiscible with the nonpolar solvent, agitating to intermix the Ag₂Se quantum dots in the colloidal suspension with the second solution whereby ligand exchange occurs, separating the Ag₂Se quantum dots from the agitated mixture; and dispersing the Ag₂Se quantum dots in a solvent to create a second colloidal suspension.

14. The process as recited in claim 13, wherein the ligand in the second solvent is selected from the group consisting of: ZnI₂, 1,2-ethanedithiol, tetrabutylammonium iodide, halide-based ligands, and thiol-based ligands.

15. The process as recited in claim 12, comprising forming a product comprising a solid layer formed of the Ag₂Se quantum dots.

16. The process as recited in claim 11, wherein the solution-based ligand exchange is performed by a non-phase transfer process.

17. The process as recited in claim 16, wherein the non-phase transfer process includes contacting the colloidal suspension with a second solution having a ligand in a second solvent that is miscible with the nonpolar solvent, agitating to intermix the Ag₂Se quantum dots in the colloidal suspension with the second solution whereby ligand exchange occurs, separating the Ag₂Se quantum dots from the agitated mixture; and dispersing the Ag₂Se quantum dots in a solvent to create a second colloidal suspension.

18. The process as recited in claim 17, wherein the ligand in the second solvent is selected from the group consisting of: ZnI₂, 1,2-ethanedithiol, and tetrabutylammonium iodide.

19. The process as recited in claim 16, comprising forming a solid layer formed of the Ag₂Se quantum dots.

20. The process as recited in claim 10, wherein an average diameter of the Ag₂Se quantum dots is in a range of about 3 nm to about 10 nm.
